(19) United States
(12) Patent Application Publication
(10) Pub. No.: US 2026/0221816 A1
(43) Pub. Date: Jul. 30, 2026

(54) MOTOR STATOR AND MOTOR

(71) Applicant: ISUZU MOTORS LIMITED, Yokohama-shi (JP)

(72) Inventor: Yusuke TAKAHASHI, Fujisawa-shi (JP)

(21) Appl. No.: 19/426,336

(22) Filed: Dec. 19, 2025

(30) Foreign Application Priority Data
Jan. 30, 2025 (JP) 2025-014188

(51) Int. Cl. H02K 1/16; H02K 3/28

(52) U.S. Cl. CPC H02K 1/16; H02K 3/28

(57) ABSTRACT

A motor stator includes a slot that is formed between adjacent teeth and has a trapezoidal cross-section, a first coil that is wound around a first tooth and provided in the slots on both sides of the first tooth , and a second coil that is wound around a second tooth located adjacent to the first tooth and provided in the slots on both sides of the second tooth. The first coil and the second coil are in contact with each other in each slot, the first coil is formed by winding a first wire having a wedge-shaped cross section in an annular shape, and the second coil is formed by winding a second wire having a rectangular cross section in an annular shape.

### CROSS-REFERENCE TO RELATED APPLICATIONS

The present application claims priority to Japanese Patent Application number 2025-14188, filed on January 30, 2025 contents of which are incorporated herein by reference in their entirety.

### BACKGROUND OF THE INVENTION

The present disclosure relates to a motor stator and a motor.

Japanese Unexamined Patent Application Publication No. H11-32457 discloses a motor in which two coils are inserted into a slot between adjacent teeth of a stator. The two coils are formed by winding a round wire having a predetermined diameter.

However, when the coil is formed by winding a round wire, it is difficult to increase the slot fill factor of the coil in a slot. In particular, in high-speed motors, the diameter of the round wire of the coil tends to be larger, thereby reducing the slot fill factor of the coil.

### BRIEF SUMMARY OF THE INVENTION

The present disclosure focuses on this point, and an object thereof is to increase the slot fill factor of a coil in a slot of a stator.

An aspect of the present disclosure provides a motor stator including a plurality of teeth that are provided at predetermined intervals in a circumferential direction of an inner wall surface, a slot that is formed between adjacent teeth and has a trapezoidal cross-section, a first coil that is wound around a first tooth among the plurality of teeth and provided in the slots on both sides of the first tooth so as to be in contact with both side surfaces of the first tooth, and a second coil that is wound around a second tooth located adjacent to the first tooth and provided in the slots on both sides of the second tooth so as to be in contact with both side surfaces of the second tooth, wherein the first coil and the second coil are in contact with each other in each slot, the first coil is formed by winding a first wire having a wedge-shaped cross section in an annular shape, and the second coil is formed by winding a second wire having a rectangular cross section in an annular shape.

A second aspect of the present disclosure provides a motor including a rotor, and a stator that surrounds an outer circumferential surface of the rotor, wherein the stator includes a plurality of teeth provided at predetermined intervals in a circumferential direction of an inner wall surface, a slot formed between adjacent teeth and having a trapezoidal cross-section, a first coil wound around a first tooth among a plurality of teeth and provided in the slots on both sides of the first tooth so as to be in contact with both side surfaces of the first tooth, and a second coil wound around a second tooth located adjacent to the first tooth and provided in the slots on both sides of the second tooth so as to be in contact with both side surfaces of the second tooth, wherein the first coil and the second coil are in contact with each other in each slot, the first coil is formed by winding a first wire having a wedge-shaped cross section in an annular shape, and the second coil is formed by winding a second wire having a rectangular cross section in an annular shape.

### BRIEF DESCRIPTION OF THE DRAWINGS

FIG. 1 schematically shows a cross-sectional configuration of a motor 1.

FIG. 2 schematically shows configurations of a first coil 20 and a second coil 30 in a slot 18.

FIG. 3 schematically shows a cross section of a first wire 60.

FIG. 4 schematically shows a cross section of a second wire 70.

FIG. 5 is a schematic diagram illustrating an order of insertion of the first coil 20 and the second coil 30 into the slot 18.

### DETAILED DESCRIPTION OF THE INVENTION

Hereinafter, the present disclosure will be described through exemplary embodiments of the present disclosure, but the following exemplary embodiments do not limit the disclosure according to the claims, and not all of the combinations of features described in the exemplary embodiments are necessarily essential to the solution means of the disclosure.

### Overview of motor 1

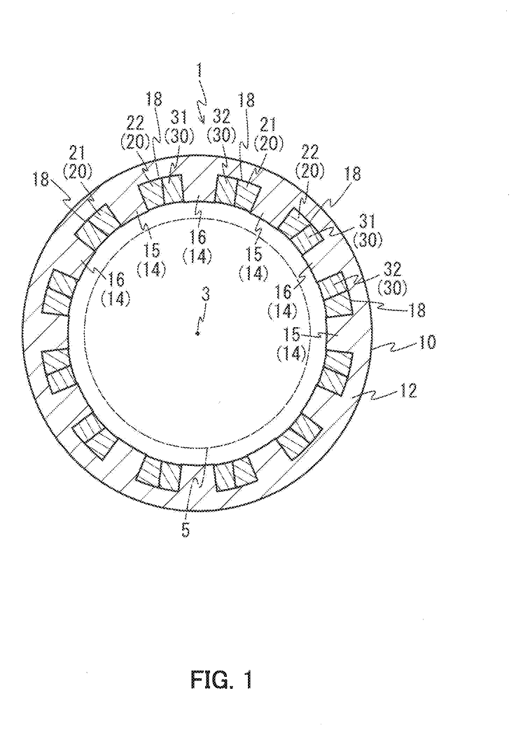

FIG. 1 schematically shows a cross-sectional configuration of a motor 1. FIG. 1 is a cross-sectional view taken along a plane orthogonal to an axial direction of a rotation shaft 3 of the motor 1 (the depth direction of the sheet in FIG. 1). The motor 1 is a motor for driving a vehicle (e.g., an electric vehicle), for example. The motor 1 here is a switched reluctance motor (SR motor), but is not limited thereto. The motor 1 includes a rotor 5 and a stator 10.

The rotor 5 is a rotor that rotates about the rotation shaft 3. The rotor 5 is rotatably supported by a bearing or the like (not shown in figures). The rotor 5 is formed by laminating magnetic steel plates in a direction along the rotation shaft 3. The rotor 5 may have salient poles (not shown in FIG. 1) protruding from an outer circumferential surface of a rotor core in a radial direction.

The stator 10 is a stator located outside the rotor 5. The stator 10 has an annular shape around the rotation shaft 3 so as to surround the outer peripheral surface of the rotor 5. The stator 10 includes a stator core 12, teeth 14, slots 18, first coils 20, and second coils 30.

The stator core 12 is formed in an annular shape. The inner wall surface of the stator core 12 surrounds the outer peripheral surface of the rotor 5. The stator core 12 is integrally formed of a magnetic material together with the teeth 14.

The teeth 14 are salient poles protruding from the inner wall surface of the stator core 12 toward the rotor 5. The plurality of teeth 14 are provided at predetermined intervals in the circumferential direction of the inner wall surface of the stator core 12. Here, the plurality of teeth 14 are provided at equal intervals in the circumferential direction. In the present embodiment, the plurality of teeth 14 include first teeth 15 and second teeth 16, with each first tooth 15 and second tooth 16 being alternately positioned in the circumferential direction. The shape of the first tooth 15 is the same as the shape of the second tooth 16.

The slot 18 is a recess formed between adjacent teeth 14 in the circumferential direction. In other words, the slot 18 is formed between a first tooth 15 and a second tooth 16. The cross section of the slot 18 here is trapezoidal in shape. Specifically, as shown in FIG. 1, the cross section of the slot 18 has a trapezoidal shape in which the width on the outer side in the radial direction is larger than the width on the inner side in the radial direction. The slots 18 are also provided at equal intervals in the circumferential direction.

A first coil 20 is a coil wound around the first teeth 15 among the plurality of teeth 14. The number of first coils 20 provided is the same as the number of first teeth 15, and each of the plurality of first coils 20 is wound around a corresponding first tooth 15.

The first coil 20 is inserted into the slots 18 on both sides of the first tooth 15 so as to straddle the first tooth 15. Therefore, the first coil 20 is located in the slots 18 on both sides of the first tooth 15. Specifically, the first coil 20 is provided in the slots 18 on both sides of the first tooth 15 so as to be in contact with both side surfaces of the first tooth 15. The first coil 20 is disposed symmetrically in the slots 18 on both sides of the first tooth 15. The first coil 20 is disposed so as to fill a part of a space (approximately half of the space) in the slot 18.

A second coil 30 is a coil wound around the second tooth 16 among the plurality of teeth 14. The number of second coils 30 provided is the same as the number of second teeth 16, and each of the plurality of second coils 30 is wound around a corresponding second tooth 16. As described above, since the first tooth 15 and the second tooth 16 are located alternately in the circumferential direction, the first coil 20 and the second coil 30 are also located alternately in the circumferential direction.

The second coil 30 is inserted into the slots 18 on both sides of the second tooth 16 so as to straddle the second tooth 16. Therefore, the second coil 30 is located in the slots 18 on both sides of the second tooth 16. Specifically, the second coil 30 is provided in the slots 18 on both sides of the second tooth 16 so as to be in contact with both side surfaces of the second tooth 16. The second coil 30 is disposed symmetrically in the slots 18 on both sides of the second tooth 16. The second coil 30 is disposed so as to fill a part of the space (approximately half of the space) in the slot 18. Therefore, a side of the first coil 20 around which the first tooth 15 is wound and a side of the second coil 30 around which the second tooth 16 is wound are located in each slot 18.

If the coils wound around the teeth 14 of the motor 1 are round wires, it is difficult to increase the slot fill factor of the coil in the slot 18. In particular, in a high-speed motor 1, the diameter of the round wire tends to be larger, thereby reducing the slot fill factor of the coil in the slot 18.

In contrast, the first coil 20 and the second coil 30 of the present embodiment are formed by winding a wire having a square cross-section, instead of a round wire. Specifically, the first coil 20 is formed by winding a first wire having a wedge shape (in other words, a trapezoidal shape) in cross section, and the second coil 30 is formed by winding a second wire having a rectangular shape (specifically, a rectangular shape having different side lengths) in cross section. Accordingly, the first coil 20 and the second coil 30 can be densely disposed in the slot 18, thereby increasing the slot fill factor of the coils in the slot 18.

### Detailed configurations of first coil 20 and second coil 30

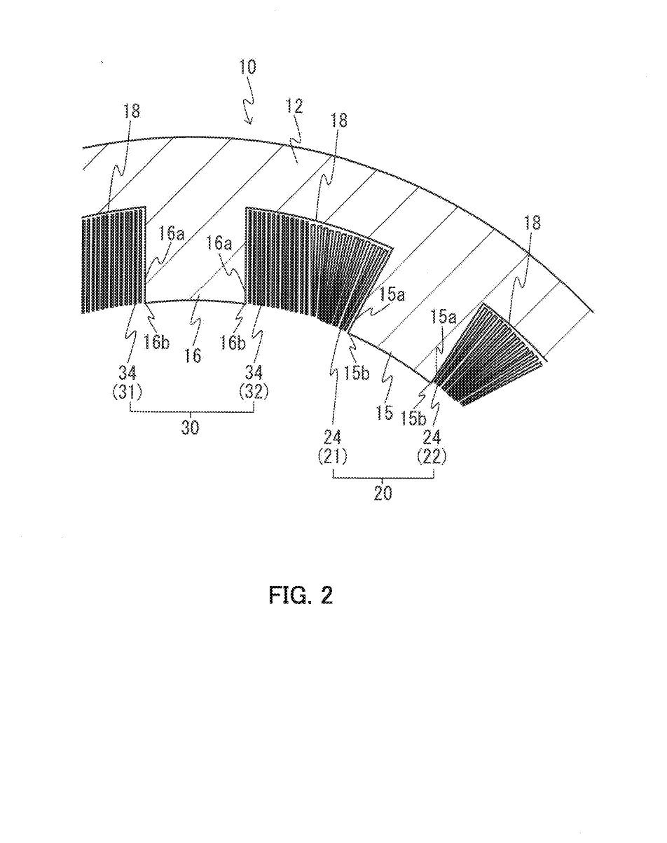

FIG. 2 schematically shows configurations of the first coil 20 and the second coil 30 in the slot 18. It should be noted that, in FIG. 2, only a portion of the motor 1 shown in FIG. 1 is shown in an enlarged manner, for convenience of explanation, and one first coil 20 and one second coil 30 are shown.

The cross section of the first coil 20 has a fan shape. Specifically, as shown in FIG. 2 , each of a left portion 21 and a right portion 22 of the first coil 20 on both sides of the first tooth 15 has a fan-shaped cross-section. The cross-sectional shape of the left portion 21 of the first coil 20 is symmetrical to the cross-sectional shape of the right portion 22 of the first coil 20 about the first tooth 15.

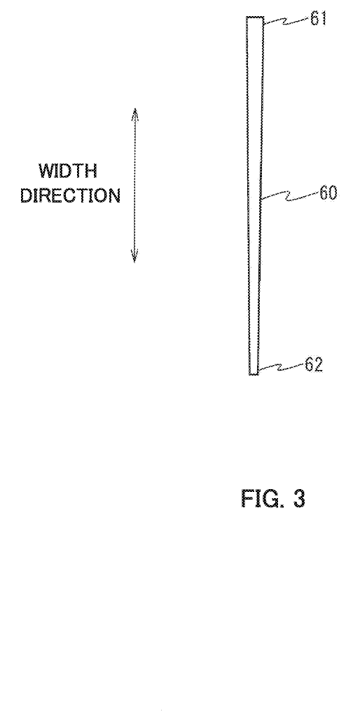

FIG. 3 schematically shows a cross section of a first wire 60. The first coil 20 is formed of the first wire 60. The first wire 60 is a long linear steel material having a predetermined width, and extends in the depth direction of the sheet in FIG. 3. The first coil 20 is formed by winding the long first wire 60 around the first tooth 15. Here, the first wire 60 is a copper wire whose surface is coated with enamel, but is not limited thereto. The cross section of the first wire 60 has a wedge shape as shown in FIG. 3. Specifically, the first wire 60 is formed in a trapezoidal shape so that the length of an end portion 61 in the width direction is larger than the length of the other end portion 62 in the width direction. The end portion 61 of the first wire 60 in the width direction corresponds to a wide portion of the first wire 60.

The first coil 20 is formed by winding the first wire 60 having the wedge-shaped cross section in an annular shape. Specifically, as shown in FIG. 2, a single first wire 60 is wound so that the left portion 21 and the right portion 22 of the first coil 20 are fan-shaped in cross section. Therefore, the left portion 21 and the right portion 22 are connected to each other. The first coil 20 is formed by bending a long side of the cross section of the first wire 60 and winding the first wire 60 into an annular shape. Specifically, the first coil 20 is formed by winding the single first wire 60 by so-called flat-wise bending. In other words, the first coil 20 is formed by bending surfaces formed by the long sides of the cross section of the first wire 60 (sides along the width direction in FIG. 3) so as to be an inner peripheral surface and an outer peripheral surface.

As shown in FIG. 2, the first coil 20 has a plurality of row portions 24 in close contact with each other. Specifically, the left portion 21 of the first coil 20 includes the plurality of row portions 24. Similarly, the right portion 22 of the first coil 20 also includes the plurality of row portions 24. The plurality of row portions 24 are in close contact with each other due to winding the first wire 60.

The row portions 24 of the left portion 21 and the right portion 22 of the first coil 20 extend along the radial direction of the stator 10. In other words, the long sides of the cross section of the first wire 60 in the first coil 20 are along the radial direction of the stator 10. As described above, by winding the first wire 60 using the flat-wise bending, the plurality of row portions 24 are formed along the radial direction of the stator 10. Therefore, the long sides of the cross section of the first wire 60 are located parallel to both side surfaces 15a of the first tooth 15. Accordingly, the surface formed by the long side of the cross section of the first wire 60 is located in the vicinity of a corner portion 15b of the first tooth 15.

In general, it is known that magnetic flux easily concentrates on the corner portion 15b of the first tooth 15, and there is a risk that the magnetic flux leaks from the corner portion 15b to the first coil 20 and eddy current is generated. In contrast, in the present embodiment, since the row portion 24 is disposed parallel to the side surface 15a of the first tooth 15, the magnetic flux leaking from the corner portion 15b of the first tooth 15 interlinks with the narrow cross section of the row portion 24 opposed to the corner portion 15b, thereby suppressing the generation of eddy current.

It should be noted that, when the first coil 20 is formed by winding a wire using so-called edgewise bending, since the direction of the row portion of the first coil 20 is orthogonal to the side surface of the first tooth 15, magnetic flux is likely to leak from the corner portion 15b of the first tooth 15 to the row portion of the first coil 20, and thus eddy current is likely to be generated.

The wide portion of the cross section of the first wire 60 (the end portion 61 shown in FIG. 3) in the first coil 20 is located on a radially outer side of the stator 10. Further, the wide portion of the cross section of the first wire 60 is adjacent to a bottom surface of the slot 18. The wide portion of the first wire 60 may be in contact with the bottom surface of the slot 18. Accordingly, the first coil 20 can be disposed on the bottom surface of the slot 18 having a trapezoidal cross section so as to increase the slot fill factor.

The cross section of the second coil 30 has a parallelogram shape. Specifically, as shown in FIG. 2, each of a left portion 31 and a right portion 32 on both sides of the second tooth 16 of the second coil 30 has a parallelogram-shaped cross-section. The cross-sectional shape of the left portion 31 of the second coil 30 is symmetrical to the cross-sectional shape of the right portion 32 of the second coil 30 about the second tooth 16.

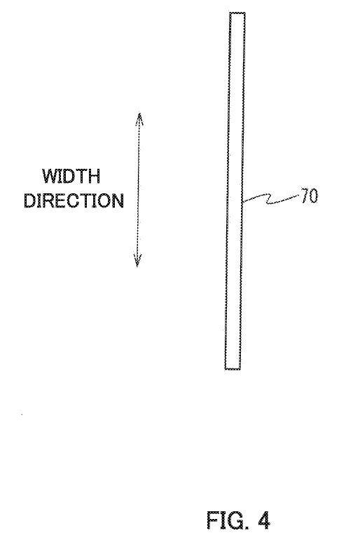

FIG. 4 schematically shows a cross section of a second wire 70. The second coil 30 is formed of the second wire 70. Similarly to the first wire 60, the second wire 70 is a long linear steel material having a predetermined width. The second wire 70 is a copper wire whose surface is coated with enamel, for example. Unlike the first wire 60, the second wire 70 has a rectangular shape (specifically, a rectangular shape having different side lengths) in cross section, as shown in FIG. 4.

The second coil 30 is formed by winding the second wire 70 having a rectangular cross section in an annular shape. Specifically, as shown in FIG. 2, a single second wire 70 is wound so that the cross-sectional shapes of the left portion 31 and the right portion 32 of the second coil 30 are parallelograms. Therefore, the left portion 31 and the right portion 32 are connected to each other. The second coil 30 is formed by bending a long side of the cross section of the second wire 70 and winding the second wire 70 into an annular shape. Specifically, the second coil 30 is formed by winding the single second wire 70 by the flat-wise bending. In other words, the second coil 30 is formed by bending surfaces formed by the long sides of the cross section of the second wire 70 (sides along the width direction in FIG. 4) so as to be an inner peripheral surface and an outer peripheral surface.

As shown in FIG. 2, the second coil 30 has a plurality of row portions 34 in close contact with each other. Specifically, the left portion 31 of the second coil 30 includes the plurality of row portions 34. Similarly, the right portion 32 of the second coil 30 also includes the plurality of row portions 34. The plurality of row portions 34 are in close contact with each other by winding the second wire 70.

The row portions 34 of the left portion 31 and the right portion 32 of the second coil 30 extend along the radial direction of the stator 10. In other words, the long sides of the cross section of the second wire 70 in the second coil 30 are along the radial direction of the stator 10. Therefore, the long sides of the cross section of the second wire 70 are located parallel to the both side surfaces 16a of the second tooth 16. Accordingly, the surface formed by the long side of the cross section of the second wire 70 is located in the vicinity of a corner portion 16b of the second tooth 16. Since the row portion 34 of the second coil 30 is disposed parallel to the side surface 16a of the second tooth 16, magnetic flux leaking from the corner portion 16b of the second tooth 16 interlinks with the narrow cross section of the row portion 34 opposed to the corner portion 16b, thereby suppressing the generation of eddy current.

Each of the plurality of row portions 34 of the second coil 30 is offset in the radial direction of the stator 10. Since the plurality of row portions 34 are offset from one another in the radial direction in this manner, the cross section of the second coil 30 has a parallelogram shape.

Since the cross-sectional shapes of the first coil 20 and the second coil 30 are different from each other, an order of insertion of the first coil 20 and the second coil 30 into the slot 18 having a trapezoidal cross-section is predetermined when manufacturing the stator 10.

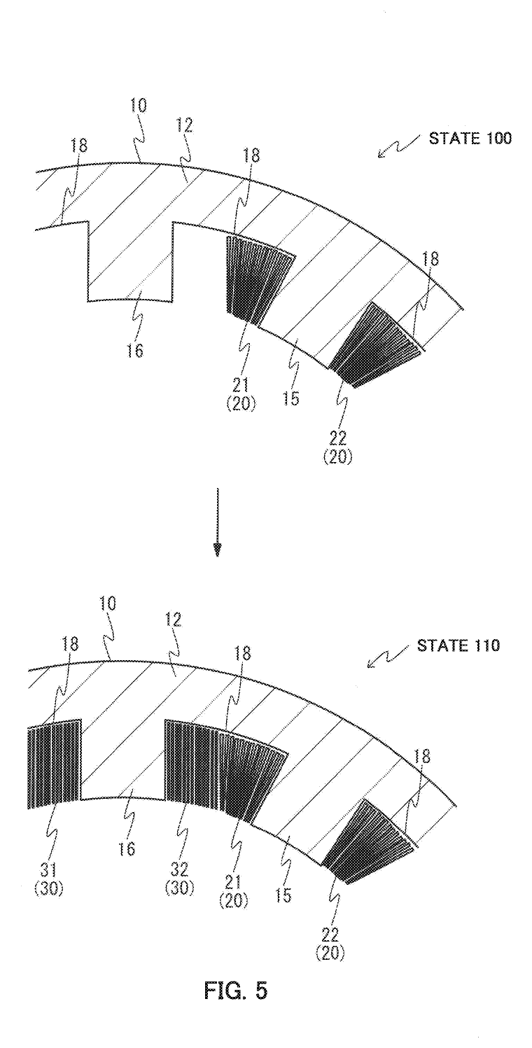

FIG. 5 is a schematic diagram illustrating the order of insertion of the first coil 20 and the second coil 30 into the slot 18. The first coil 20 is inserted into the slots 18 so that the first coil 20 straddles the first tooth 15 (see state 100). Then, the second coil 30 is inserted into the slots 18 so that the second coil 30 straddles the second tooth 16 (see state 110). Accordingly, the first coil 20 and the second coil 30 can be densely inserted into the slot 18 having a trapezoidal cross section, and as a result, the slot fill factor of the first coil 20 and the second coil 30 can be increased.

The first coil 20 and the second coil 30 are in contact with each other within the slot 18. Specifically, the first coil 20 and the second coil 30 are bonded to each other on surfaces facing each other. For example, the first coil 20 and the second coil 30 are bonded to each other by an adhesive or an adhesive seal. The bonding of the first coil 20 and the second coil 30 is performed after the first coil 20 and the second coil 30 are inserted into the slot 18.

The first coil 20 and the second coil 30 having different cross-sectional shapes are bonded, thereby preventing the first coil 20 and the second coil 30 from coming out from the slot 18 without providing a stop member that connects the corner portion 15b of the first tooth 15 and the corner portion 15b of the second tooth 16. Further, since there is no need to provide a stop member, the first coil 20 and the second coil 30 can be disposed adjacent to the corner portion 15b of the first tooth 15 and the corner portion 16b of the second tooth 16, and thus the slot fill factor of the coils in the slot 18 can be increased.

### Effects of the embodiment

The stator 10 of the above-described embodiment includes the first coil 20 provided in contact with both side surfaces of the first tooth 15 in the slots 18 on both sides of the first tooth 15, and the second coil 30 provided in contact with both side surfaces of the second tooth 16 in the slots 18 on both sides of the second tooth 16. The first coil 20 is formed by bending the first wire 60 having a wedge-shaped cross section in an annular shape, and the second coil 30 is formed by bending the second wire 70 having a rectangular cross section in an annular shape.

Accordingly, since the first coil 20 and the second coil 30 can be densely disposed in the slot 18 having a trapezoidal cross section, the slot fill factor of the coils in the slot 18 can be increased.

In addition, since the row portion 24 of the first coil 20 facing the side surface 15a of the first tooth 15 extends along the radial direction of the stator 10, it is possible to suppress the generation of eddy current due to the leakage of magnetic flux from the corner portion 15b of the first tooth 15. Similarly, since the row portion 34 of the second coil 30 facing the side surface 16a of the second tooth 16 extends along the radial direction of the stator 10, it is possible to suppress the generation of eddy current due to leakage of magnetic flux from the corner portion 16b of the second tooth 16.

The present disclosure is explained on the basis of the exemplary embodiments. The technical scope of the present disclosure is not limited to the scope explained in the above embodiments and it is possible to make various changes and modifications within the scope of the disclosure. For example, all or part of the apparatus can be configured with any unit which is functionally or physically dispersed or integrated. Further, new exemplary embodiments generated by arbitrary combinations of them are included in the exemplary embodiments of the present disclosure. Further, effects of the new exemplary embodiments brought by the combinations also have the effects of the original exemplary embodiments.

1. A motor stator comprising:
a plurality of teeth that are provided at predetermined intervals in a circumferential direction of an inner wall surface;
a slot that is formed between adjacent teeth and has a trapezoidal cross-section;
a first coil that is wound around a first tooth among the plurality of teeth and provided in the slots on both sides of the first tooth so as to be in contact with both side surfaces of the first tooth; and
a second coil that is wound around a second tooth located adjacent to the first tooth and provided in the slots on both sides of the second tooth so as to be in contact with both side surfaces of the second tooth, wherein
the first coil and the second coil are in contact with each other in each slot,
the first coil is formed by winding a first wire having a wedge-shaped cross section in an annular shape, and
the second coil is formed by winding a second wire having a rectangular cross section in an annular shape.

2. The motor stator according to claim 1, wherein
a long side of a cross section of the first wire in the first coil is along a radial direction of the stator, and
a long side of a cross section of the second wire in the second coil is along the radial direction.

3. The motor stator according to claim 1, wherein
a cross section of the first coil has a fan shape, and
a cross section of the second coil has a parallelogram shape.

4. The motor stator according to claim 1, wherein
a wide portion of a cross section of the first wire in the first coil is located on a radially outer side of the stator and is in contact with a bottom surface of the slot.

5. The motor stator according to claim 1, wherein
the first coil is formed by bending a long side of a cross section of the first wire and winding the first wire into an annular shape, and
the second coil is formed by bending a long side of a cross section of the second wire and winding the second wire into an annular shape.

6. The motor stator according to claim 5, wherein
the second coil has a plurality of row portions that are in close contact with each other by winding the second wire, and
each of the plurality of row portions is offset in a radial direction of the stator.

7. The motor stator according to claim 1, wherein
the first coil and the second coil are bonded to each other on surfaces facing each other.

8. A motor comprising:
a rotor; and
a stator that surrounds an outer circumferential surface of the rotor, wherein
the stator includes:
a plurality of teeth provided at predetermined intervals in a circumferential direction of an inner wall surface,
a slot formed between adjacent teeth and having a trapezoidal cross-section,
a first coil wound around a first tooth among a plurality of teeth and provided in the slots on both sides of the first tooth so as to be in contact with both side surfaces of the first tooth, and
a second coil wound around a second tooth located adjacent to the first tooth and provided in the slots on both sides of the second tooth so as to be in contact with both side surfaces of the second tooth, wherein
the first coil and the second coil are in contact with each other in each slot,
the first coil is formed by winding a first wire having a wedge-shaped cross section in an annular shape, and
the second coil is formed by winding a second wire having a rectangular cross section in an annular shape.
